(19) United States
(12) Patent Application Publication
(10) Pub. No.: US 2015/0292049 A1
(43) Pub. Date: Oct. 15, 2015

(54) FLASH COOLING FOR QUENCHING A HYDROLYSIS REACTION OF A BIOMASS FEEDSTOCK

(71) Applicant: REAC FUEL AB, Lund (SE)

(72) Inventors: Anders Carlius, Lund (SE); Andreas Gram, Hoor (SE); Göran Karlsson, Helsingborg (SE); Haukur Jóhannesson, Lund (SE); Torsten Werner, Billinge (SE)

(21) Appl. No.: 14/441,427

(22) PCT Filed: Nov. 8, 2013
(86) PCT No.: PCT/SE2013/051324

§ 371 Date: May 7, 2015

(30) Foreign Application Priority Data
Nov. 8, 2012 (SE) PCT/SE2012/051215
May 8, 2013 (SE) 1350577-1

(51) Int. Cl. C13K 1/02; B01J 3/00

(52) U.S. Cl. CPC C13K 1/02; B01J 3/006; B01J 2203/00

(57) ABSTRACT

The present invention describes a process for quenching a hydrothermal, dilute acid hydrolysis reaction of a biomass feedstock, wherein degradation of an aqueous monomer and/or oligomer sugar mixture is slowed down or stopped by flash cooling of the aqueous monomer and/or oligomer sugar mixture, and wherein the flash cooling ensures that a fraction of dissolved and volatile degradation byproducts are removed by a forming vapor stream, and wherein a lignin component, if present, is solidified into a structure with good de-watering characteristics, allowing for subsequent removal of the lignin component by separation, said process resulting in a hydrolyzed solution of sugar monomers and/or oligomers.

### FIELD OF THE INVENTION

The present invention relates to a method for quenching a liquefaction reaction of a lignocellulosic biomass starting material, to avoid continued detrimental decomposition, for the production of a monomer and/or oligomer sugar mixture solution.

### TECHNICAL BACKGROUND

It has long been known to quench different types of reactions. Quenching implies stopping the reaction or slowing it down and this may be performed by different means, such as by lowering the temperature, reducing the pressure, adding substances, etc.

Moreover, to quench different forms of biomass reactions has also been described. For example, in WO01/88258 there is disclosed a continuous process for the conversion of biomass to form a chemical feedstock. The biomass and an exogenous metal oxide, preferably calcium oxide, or metal oxide precursor are continuously fed into a reaction chamber that is operated at a temperature of at least 1400° C. to form reaction products including metal carbide. The reaction products are quenched to a temperature of 800° C. or less. The resulting metal carbide is separated from the reaction products or, alternatively, when quenched with water, hydrolyzed to provide a recoverable hydrocarbon gas feedstock.

Furthermore, in WO2007/128798 there is disclosed a process for converting a solid or highly viscous carbon-based energy carrier material to liquid and gaseous reaction products, said process comprising the steps of: a) contacting the carbon-based energy carrier material with a particulate catalyst material b) converting the carbon-based energy carrier material at a reaction temperature between 200° C. and 450° C., preferably between 250° C. and 350° C., thereby forming reaction products in the vapor phase. The process may comprise the additional step of: c) separating the vapor phase reaction products from the particulate catalyst material within 10 seconds after said reaction products are formed; and d) quenching the reaction products to a temperature below 200° C.

Moreover, to quench e.g. the liquefaction of biomass, for instance being performed in sub- or super-critical conditions, has also been addressed in the past. For instance, in US2010/0063271, there is disclosed a “dynamic” supercritical fluid biomass conversion system for continuously converting a selected biomass material into a plurality of reaction products, and comprises, in fluidic series: a biomass conveying zone; a supercritical fluid biomass conversion zone within an electrically conductive housing and about a central axis; and a reaction product quenching/separation zone. According to the examples, it is disclosed that the fully loaded pressure vessel was subjected to a time-variable magnetic field by energizing the induction coil with alternating electric current that ranged from about 50-100 KHZ for a period of time ranging from about 2 to 5 seconds. After energizing, the vessel was rapidly cooled by way of quenching with a cascading flow-stream of water.

Furthermore, another quenching by lowering the temperature is disclosed in US2011/0300617. In US2011/0300617 there is disclosed a biomass hydrothermal decomposition apparatus that feeds a solid biomass material from one side of an apparatus body, feeds pressurized hot water from the other side, to hydrothermally decompose the biomass material while bringing the biomass material into counter contact with the pressurized hot water, dissolves hot-water soluble fractions in hot water, discharges the pressurized hot water to outside from the one side of the apparatus body as a hot-water effluent, and discharges a biomass solid to the outside from the other side. Advantageously, in the biomass hydrothermal decomposition apparatus, the internal-temperature cooling unit adjusts a temperature to be in a temperature drop region, in which the temperature is rapidly dropped to a temperature at which hot-water soluble fractions are not excessively decomposed, immediately after completion of hydrothermal decomposition, e.g. from 200° C. to 140° C. or less.

The present invention is directed to providing an optimal method for quenching a biomass material which is undergoing liquefaction in a sub- or super-critical condition.

### SUMMARY OF THE INVENTION

The latter stated purpose above is achieved by a process for quenching a hydrothermal, dilute acid hydrolysis reaction of a biomass feedstock, wherein degradation of an aqueous monomer and/or oligomer sugar mixture is slowed down or stopped by flash cooling, also known as flash evaporation, of the aqueous monomer and/or oligomer sugar mixture, and wherein the flash cooling ensures that a fraction of dissolved and volatile degradation byproducts are removed by a forming vapor stream, and wherein a lignin component, if present, is solidified into a structure with good de-watering characteristics, allowing for subsequent removal of the lignin component by separation, said process resulting in a hydrolyzed solution of sugar monomers and/or oligomers.

In relation to the present invention, the expression “flash cooling” does not only imply a regular cooling, and thus, the expression “wherein the flash cooling ensures that a fraction of dissolved and volatile degradation byproducts are removed by a forming vapor stream” is also essential according to the present invention. Flash cooling according to the present invention implies that flash evaporation has occurred. Flash evaporation is the process in which a vapor phase is formed when a liquid undergoes a pressure reduction below its vapor pressure. Both the vapor and the residual liquid are cooled, i.e. flash cooled, to the saturation temperature of the liquid at the reduced pressure.

In WO2011/091044 there is disclosed a method for the continuous treatment of biomass, wherein the biomass is contacted with a first supercritical, near-critical, or sub-critical fluid to form a solid matrix and a first liquid fraction; and a hydrolysis step wherein the solid matrix formed in said pretreatment step is contacted with a second supercritical or near-supercritical fluid to produce a second liquid fraction and a insoluble lignin-containing fraction. In WO2011/091044 flash cooling is mentioned as a possible cooling step, however in this case to a very low temperature implying a different type of input stream being flash cooled and thus a different process in terms of conditions when compared to the present invention. Furthermore, in WO2011/091044 the supercritical, near-critical, or sub-critical fluid may comprise CO₂. Furthermore, separation and subsequent treatment is also different when compared to the present invention.

There are several aspects of interest in relation to the present invention. One obvious first is a high yield of monomer and/or oligomers in the final solution, and where the degradation has not been driven too far. According to the present invention the concentration of the product solution will be affected by the removal of the generated vapor fraction in the flash step/steps. The process conditions may vary from e.g. a two-phase system with one solid phase and one liquid phase to a system in which the liquid is adsorbed/absorbed to the solid phase, all variants according to the present invention still possible to yield highly concentrated sugars without the need for e.g. evaporator operations.

Besides the temperature and pH affecting the degradation of an aqueous monomer and/or oligomer sugar mixture during the hydrolysis, also other aspects may be of importance. One such is the formation of harmful products, i.e. inhibitors of fermentation and/or anaerobic digestion, and of course keeping such levels as low as possible, such as e.g. by the removal of such inhibitors. Another is to optimize the conditions to achieve cellulose de-crystallization.

Other central aspects of the present invention are related to if lignin is present, and in that case making sure to obtain a lignin freeze and solidification thereof, allowing for lignin release and separation of the same. Moreover, heat recovery and recovery of byproducts may also be aspects of central interest.

### SPECIFIC EMBODIMENTS OF THE INVENTION

Below specific embodiments of the present invention are discussed. According to one specific embodiment, the flash cooling is performed in only one step. According to another specific embodiment, the flash cooling is performed in at least two steps. It should be noted that also several steps, such as three or four, or even more, is possible according to the present invention, in which the pressure and hence the temperature, is reduced in several steps. The pressure of the flash tank determines the temperature of the product solution, according to the vapor temperature/pressure relation of water and other volatile substances and is the primary means of controlling the flash and is as such an important parameter. The temperature and pressure immediately before and after the flash step determines the amount of vapor that is generated. From an energy efficiency or energy recovery point of view several steps may be beneficial.

The magnitude of the temperature reduction is of course an important parameter for the flash cooling. This may vary depending on the number of steps employed, the starting material used, other conditions, etc. According to one specific embodiment of the present invention, the entire flash cooling, performed in one or more steps, is performed to a temperature in the range of 40-280° C., such as to a temperature in the range of 50-270° C., 60-260° C., 70-250° C., 80-240° C., 90-240° C., 40-230° C., 40-210° C., 100-230° C. or 100-210° C.

According to one embodiment the flash cooling may be performed together with different means of heat transfer, e.g. heat exchangers, direct steam heating, combination with wall heating etc.

Moreover, if several flash cooling steps are used, this may also affect the temperature used in the different steps. According to one embodiment, a first flash cooling step is performed to a temperature in the range of 190-220° C. and a second flash cooling step is performed to a temperature in the range of 100-190° C. If only one flash cooling step is used, then the temperature used may be considerably lower than the ones disclosed above.

The temperature used also affects the allowable residence time in the flash tank. According to one specific embodiment of the present invention, the flash cooling is performed in a first flash unit at a temperature in the range of 190-220° C. and wherein the residence time is no longer than 10 minutes in the first flash unit. The residence time may e.g. be at most 7, at most 5 or at most 3 minutes, in the above mentioned first flash step.

As described below, a second flash may transform molten lignin to solid quickly without risking clogging or fouling. In such case the flash inlet may be adjusted so that lignin get a particulate structure allowing subsequent efficient dewatering and avoid clogging on walls. For example, in one embodiment of the invention a first flash step reduces the pressure from the process conditions of the reactor to a pressure of about 20 bar resulting in a temperature of about 212° C. At this temperature the lignin may still be in a non-solid form. A second flash step may then reduce the pressure to e.g. 5 bar reducing the temperature to 152° C., which is below the solidification temperature interval of lignin. This solid lignin may then be removed by a separation technique.

As stated previously the pressure is an important parameter. The hydrothermal hydrolysis is performed at an elevated temperature and pressure. The pressure is controlled/regulated by a pressure control device that is positioned just before a flash vessel. The pressure is reduced over said control device and the process medium flashes if and when the pressure drops below the boiling pressure corresponding to the reaction/process temperature of the process medium. Flashing begins already inside the pressure control device and continues as it enters the flash vessel. The pressure inside the flash vessel is controlled by regulating on the vapor outlet stream primarily, but also on the liquid phase as well.

According to one possible set-up, the flash cooling is performed in at least one flash tank, which is preceded by a pressure control/reduction device. As such, the process pressure and/or the temperature may be reduced somewhat before the active flash cooling.

Furthermore, and as mentioned above, heat recovery may be a key question for the entire process. Therefore, according to one embodiment, generated flash vapor is used to heat other process operations. In one embodiment the vapor generated in a flash step can be used to heat other process operations by passing said vapor through a heat exchanger, used outside the process or as heating media e.g. as direct steam. One way of making use of the vapor could be to directly connect a flash vessel vapor outlet to a heat exchanger, e.g. flash no 1 which could generate about 20 bar vapor at 212° C. can be directly connected to a heat exchanger which then could pre-heat the process flow to roughly 200° C. An alternative design could be to use a steam manifold system with multiple steam tanks at suitable pre-determined pressures. The number of steam manifold tanks should at least equal the number of flash steps. A specific flash step would be connected to the appropriate steam manifold tank and thus the generated vapor would pass into said tank. From said steam manifold tank the steam/vapor can be directed to any point of use. The boiler that supports the process with high pressure steam will also support the steam manifold tanks so that there is always enough steam/vapor available to cover the need. The high pressure steam will be pressure reduced and desuperheated to the desired level. This kind of setup will also simplify startup since there will always be steam/vapor available to heat upstream processes, even at start up. A drawback of the mentioned solution is that volatile compounds exiting the flash vessels with the vapor will also end up in the steam manifold system. A volatile compound that is interesting as a possible product will be diluted in the steam manifold tank(s) which then could make recovery less interesting from an economical point of view. If a considerable fraction of the volatile compounds are acids this could also have an impact on the choice of material in the steam manifold tanks and in turn an economic impact.

Based on the above described, according to one specific embodiment of the present invention, a pressure control device is arranged in the process just upstream of a flash vessel, and is either a i) control/throttling valve, e.g. of a needle valve-type, ball sector valve-type, eccentric plug valve type, slide valve-type, or the like, ii) small inner diameter pipe, iii) an orifice plate, iv) a reverse acting pump, e.g. a piston pump or progressing cavity pump or v) a combination of any of the mentioned devices in i)-iv).

The process may of course also comprise other operations and devices. According to one embodiment, the process also involves distillation, adsorption, absorption, filtration and/or separation and recovery of byproducts. When heat is recovered, volatile components, such as furfuraldehyde and formic acid, may be separated from the main stream. As such, these components may be removed from the main monomer and oligomer solution. For the separation a distillation column may be used. Other alternatives are a system for reverse osmosis or a molecular sieve.

As an example, byproducts having a high boiling point may be separated from a gas phase (steam) by partial condensation in combination with a distillation column or membrane filtration or absorption agents. Furthermore, byproducts having a low boiling point may also be recovered by absorption and/or membrane processes or by total condensation where the heat is used to generate a pure steam by boiling pure water.

Furthermore, the process may also involve adding an additive in the flash cooling step. Examples are a base and/or a defoamer. If the solution consists mainly of sugar monomers, and if the temperature and pH is unfavorable, a residence time of a few minutes could produce unwanted by-products. One way of reducing this problem could be to increase the pH by injecting a base (caustic solution), such as sodium hydroxide. This would require an additional inlet to the flash tank. An additive selected from a dispersing agent and/or a caustic solution may also be added before a separation of a liquid phase from a solid phase is performed. The caustic solution may be chosen from e.g. sodium hydroxide or potassium hydroxide, or a combination, and the dispersing agent may e.g. be chosen from lignosulphonates, polyacrylates, sulphonates, carboxylates, salts of lecithin, and SASMAC. The lignosulphonates may e.g. be chosen from ammonium lignosulphonate, sodium lignosulphonate, calcium lignosulphonate, magnesium lignosulphonate, and ferrochrome lignosulphonate, or any combination thereof. The polyacrylates may be chosen from sodium, potassium, lithium and ammonium polyacrylates, or any combination thereof.

The polyacrylates may be chosen from e.g. polymers formed from the acrylate monomers acrylic acid, methacrylate, acrylonitrile, methyl acrylate, ethyl acrylate, 2-chloroethyl vinyl ether, 2-ethylhexyl acrylate, hydroxyethyl methacrylate, butyl acrylate, butyl methacrylate, or TMPTA, or any combination thereof.

Furthermore, if foaming is a problem addition of chemicals such as defoamers can be added for foam suppression. For this embodiment a second inlet is required.

The biomass feedstock may be of different type according to the present invention. According to the present invention both lignocellulosic biomass and biomass containing only low levels of lignin or pre-treated solutions in which such components have been removed are possible.

Therefore, according to one embodiment, the aqueous monomer and/or oligomer sugar mixture being subjected to the flash cooling comprises water soluble hem icelluloses, solid cellulose and lignin, and wherein said process results in a delignified solution of sugar monomer and/or oligomers. In this case the solution to be treated typically is a product solution from a hydrolysis of a solution containing high levels of hemicelluloses. In relation to the expression “delignified solution of sugar monomer and/or oligomers” it may be noted that at least a fraction of the lignin, such as about 15%, is transformed into phenol derivatives in the solution. At least some of these, if not all of them, are still present in the sugar solution after the flash cooling according to the present invention. Phenols may, however, be removed in different ways, e.g. by use of activated carbon, serdolit, use of a cooling trap, pH lowering, etc.

According to yet another embodiment of the present invention, the aqueous monomer and/or oligomer sugar mixture being subjected to the flash cooling comprises water soluble cellulose oligomers (water soluble oligomers originating from cellulose) and solid lignin, and wherein said process results in a delignified solution of sugar monomer and/or oligomers. Water soluble cellulose oligomers are typically cellobiose, cellotriose, etc., but the solution may also potentially contain unreacted cellulose also after the treatment. In this case the solution to be treated typically is a product solution from a hydrolysis of a solution containing high levels of cellulose.

According to yet another embodiment, the aqueous monomer and/or oligomer sugar mixture being subjected to the flash cooling comprises water soluble sugar components originating from hemicelluloses and cellulose, and solid lignin, and wherein said process results in a delignified solution of sugar monomer and/or oligomers. In this case the solution to be treated is a combination of the two above, and may as such typically be the result in a one-step hydrolysis process.

As hinted above, according to yet another embodiment the starting material does not contain much lignin or no lignin, and where the aqueous monomer and/or oligomer sugar mixture being subjected to the flash cooling comprises water soluble sugar components originating from hemicelluloses and/or cellulose.

The hydrolysis according to the present invention may be performed in one or more steps. Therefore, according to one embodiment, the step of flash cooling is preceded by the hydrothermal, dilute acid hydrolysis performed as a thermal treatment in either one step or several steps, such as one or two steps, or even multiple steps. According to one specific embodiment, the step of flash cooling is preceded by a first thermal treatment step in which the biomass feedstock is subjected to treatment with hot compressed liquid water (HCW) at subcritical conditions and/or steam during a residence time T₁, and a second hydrolysis step in which the lignocellulosic biomass feedstock is further treated in at least hot compressed liquid water (HCW) at subcritical conditions during a residence time T₂ for the depolymerisation of carbohydrates to produce an aqueous monomer and/or oligomer sugar mixture. In a two-step process, a separation step in form of e.g. filtration may be provided in between the different thermal treatment steps. Steam injection may be used as a means to increase the temperature of the process flow during the thermal treatment step(s).

The temperature and residence time in the different steps may vary. In a multiple step version, the first step involves a temperature increase and the second step may imply that the temperature is held constant or further increased. Different temperature profiles are of course possible. The way to reach the desired process temperatures and temperature profile(s) can be done through either indirect heating, e.g. through the use of a heat exchanger or other means of barrier heating, or by direct heating, e.g. by steam injection.

Moreover, according to one specific embodiment, at least one of the steps of thermal treatment involves a pH decrease. Such a pH decrease may occur naturally in view of the production of organic acids, such as acetic acid, during the hydrolysis. A further pH decrease may also be achieved by the addition of an acid during the hydrolysis. Such acids may be organic or inorganic, and examples or organic acids are aliphatic carboxylic acids, aromatic carboxylic acids, dicarboxylic acids, aliphatic fatty acids, aromatic fatty acids, and amino acids, or any combination, and examples of inorganic acids are sulfuric acid, sulfonic acid, phosphoric acid, phosphonic acid, nitric acid, nitrous acid, hydrochloric acid, hydrofluoric acid, hydrobromic acid, and hydroiodic acid, or any combination. It should, however be noted that, the method according to the present invention may be performed free from any other added solvents besides HCW and possibly cold water (see below).

According to one specific embodiment, with reference to an acidic hydrolysis, the pH value during the the thermal treatment is at most 4, such as in the range of 1-4, e.g. in the range of 1.2-3.3.

According to another specific embodiment, the hydrolysis step, performed in one or several steps, is performed in one step at a temperature of at least 200° C. or in at least two steps where a first thermal treatment step is performed at a temperature of at least 170° C., for a so called hemi cellulose-step, and a second treatment step, a so called cellulose-step, at a temperature of at least 200° C. According to yet another specific embodiment, the hydrothermal, dilute acid hydrolysis is performed in one step at a temperature range of 220-280° C. or in at least two steps where a second or later thermal treatment step is performed at a temperature range of 220-280° C. According to yet another specific embodiment, the temperature in a one-step hydrolysis or as the second cellulose-step in a two-step hydrolysis is in the range of 200-370° C., e.g. in the range of 230-350° C., e.g. 200-300° C., such as in the range of 220-280° C.

Furthermore, according to yet another specific embodiment of the present invention, the flash cooling is combined with cold or tempered water injection, with or without sugar monomers and oligomers, in one or several steps. Quenching may as such be obtained by different means according to the present invention, however flash cooling is always present in the method. The entire quenching cycle may be fast according to the present invention. A first or in some cases single flash cooling step according to the present invention may e.g. be performed so that the post-quenching temperature is reached within a time of maximum 10 seconds, for example reached within a time of maximum 2 seconds. This is also valid for such a step being combined with a water injection step according to the present invention. However, it is of course of importance how the temperature profiles look, and with e.g. a temperature profile where the temperature drops very quickly after which it slowly approaches the target temperature, then the time needed and used may be considerably longer in comparison.

Moreover, the liquefaction may be performed sequentially in at least two separate reactors, e.g. where separation of a liquid phase is performed after each reactor. Moreover, the liquefaction may be performed in a continuous flow system. In addition to separation according to above, also one or multiple washing steps may be involved in the present process, especially if the content of solid matter is comparatively high. In such a case this may be of importance to extract a high level of monomers and oligomers from the solid part in the process flow. The washing step(s) may involve the use of water with or without added acid. The washing operations are further mentioned below.

Furthermore, the solid content of the biomass feedstock may vary. According to one embodiment, the total solid content of the biomass feedstock during the thermal treatment is in the range of 5-90%. It should be noted that the present invention encompasses treating all kinds of biomass feedstocks, e.g. slurries with comparatively lower level of solid content and e.g. relatively dense humid biomass feedstocks having high solid content. Preferably, the total solid content of the biomass feedstock during the thermal treatment is in the range of 10-50%.

Moreover, the hydrothermal, dilute acid hydrolysis possible according to the present invention may be performed in one or several steps. According to one specific embodiment, the hydrothermal, dilute acid hydrolysis is performed in at least two steps and wherein dissolved water soluble compounds are separated from a solid residue after the first step to prevent continued detrimental degradation. For instance, the process stream may be filtrated to separate a solid and liquid phase to perform this operation. According to yet another embodiment, the hydrothermal, dilute acid hydrolysis is performed in at least two steps and wherein a solid residue after the first step is rinsed from water soluble compounds by washing with water, followed by additional liquid-water separation. This may be seen as one phase washing, however also washing in two phases is possible. Therefore, according to one specific embodiment, the step of flash cooling is preceded by the hydrothermal, dilute acid hydrolysis performed as a thermal treatment in either one step or several steps and wherein a solid residue is rinsed from water soluble compounds, followed by additional liquid-water separation, in a repeated fashion.

Moreover, according to yet another embodiment of the present invention, wherein the step of flash cooling is preceded by the hydrothermal, dilute acid hydrolysis performed as a thermal treatment in either one step or several steps and wherein a solid residue is rinsed from water soluble compounds by adding acidified water in a last washing step. This addition of acidified water may be performed to adjust the pH vale before the second hydrolysis step in a possible second reactor.

Moreover, the reaction time of the liquefaction and hydrolysis may vary, but may be short, such as below 1 minute, e.g. between 1 and 45 seconds.

Moreover, the method may also comprise removal of non-solubilised material, such as for the produced solid lignin components or lignin derivative components, or other such components involved. Separation and recovery or reuse of unreacted cellulose may also be provided.

Furthermore, the method may also involve step(s) for preventing, minimizing or eliminating clogging and/or fouling of sticky biomass components in process equipment, such as by an alkaline liquid being washed through the process equipment, either as a sole solution between regular process operations of a biomass process flow in a liquid solution, or as added directly into the liquid solution for dissolving biomass components which are or otherwise may become sticky. Such an alkaline liquid may be processed separately from the biomass process flow solution after the washing or the addition thereof. Moreover, the alkaline liquid may be recovered after the washing or addition thereof, for further washing or addition. The alkaline liquid may be a liquid based on caustic liquor (sodium hydroxide) or ammonia. Moreover, an oxidizing agent may also be added in the alkaline liquid.

Flash tanks and outer devices and hardware used in a process according to the present invention may have different design. In addition, the number thereof may also vary. One possible flash tank according to one embodiment has at least one inlet, for the product solution, and two outlets, for the vapor and the liquid phase. Typically a residence time of a few minutes for the liquid phase is required in the flash tank in order to allow the liquid to settle. As hinted above, such flash tanks may be combined in series or parallel.

Furthermore, the flash tanks can be considered as secondary reactors because continued reactions can occur depending on temperature, acidity and residence times. This could be beneficial for some types of product solutions, e.g. if they consist of water soluble sugar oligomers. However, if the solution consists mainly of sugar monomers, and if the temperature and pH is unfavorable, a residence time of a few minutes could produce unwanted by-products. One way of reducing this problem could be to increase the pH by injecting a base, such as sodium hydroxide, such as mentioned above. This would require an additional inlet to the flash tank.

1. A process for quenching a hydrothermal, dilute acid hydrolysis reaction of a biomass feedstock, wherein degradation of an aqueous monomer and/or oligomer sugar mixture is slowed down or stopped by flash cooling of the aqueous monomer and/or oligomer sugar mixture, and wherein the flash cooling ensures that a fraction of dissolved and volatile degradation byproducts are removed by a forming vapor stream, and wherein a lignin component, if present, is solidified into a structure with good de-watering characteristics, allowing for subsequent removal of the lignin component by separation, said process resulting in a hydrolysed solution of sugar monomers and/or oligomers.

2. The process according to claim 1, wherein the flash cooling is performed in only one step.

3. The process according to claim 1, wherein the flash cooling is performed in at least two steps.

4. (canceled)

5. The process according to claim 1, wherein the entire flash cooling, performed in one or more steps, is performed in a temperature range of 100-230° C.

6. (canceled)

7. The process according to claim 3, wherein a first flash cooling step is performed in a temperature range of 190-220° C. and a second flash cooling step is performed in a temperature range of 100-190° C.

8. (canceled)

9. The process according to claim 1, wherein the aqueous monomer and/or oligomer sugar mixture being subjected to the flash cooling comprises water soluble hemicelluloses, solid cellulose and lignin, and wherein said process results in a hydrolysed delignified solution of sugar monomer and/or oligomers.

10. The process according to claim 1, wherein the aqueous monomer and/or oligomer sugar mixture being subjected to the flash cooling comprises water soluble cellulose oligomers and solid lignin, and wherein said process results in a hydrolysed delignified solution of sugar monomer and/or oligomers.

11. (canceled)

12. (canceled)

13. The process according to claim 1, wherein generated flash vapor is used to heat other process operations.

14. (canceled)

15. (canceled)

16. The process according to claim 1, wherein the process also involves adding an additive in the flash cooling step.

17. (canceled)

18. The process according to claim 1, wherein the step of flash cooling is preceded by the hydrothermal, dilute acid hydrolysis performed as a thermal treatment in either one step or several steps.

19. The process according to claim 1, wherein the step of flash cooling is preceded by a first thermal treatment step in which the biomass feedstock is subjected to treatment with hot compressed liquid water (HCW) at subcritical conditions and/or steam during a residence time T₁, and a second hydrolysis step in which the lignocellulosic biomass feedstock is further treated in at least hot compressed liquid water (HCW) at subcritical conditions during a residence time T₂ for the depolymerisation of carbohydrates to produce an aqueous monomer and/or oligomer sugar mixture.

20. The process according to claim 19, wherein at least one of the steps of thermal treatment involves a pH decrease.

21. The process according to claim 19, wherein the pH value during the thermal treatment is at most 4.

22. (canceled)

23. The process according to claim 18, wherein the pH value during at least one of the steps of thermal treatment is in the range of 1.2-3.3.

24. The process according to claim 18, wherein the hydrothermal, dilute acid hydrolysis comprises or is preceded by the addition of inorganic and/or organic acids.

25. The process according to claim 1, wherein the hydrothermal, dilute acid hydrolysis is performed in one step at a temperature of at least 200° C. or in at least two steps where a first thermal treatment step is performed at a temperature of at least 170° C. and a second treatment step at a temperature of at least 200° C.

26. The method according to claim 1, wherein the hydrothermal, dilute acid hydrolysis is performed in one step at a temperature range of 220-280° C. or in at least two steps where a second or later thermal treatment step is performed at a temperature range of 220-280° C.

27. (canceled)

28. The process according to claim 1, wherein the flash cooling is performed in a first flash unit at a temperature in the range of 190-220° C. and wherein residence time is no longer than 10 minutes in the first flash unit.

29. (canceled)

30. The process according to claim 1, wherein the total solid content of the biomass feedstock during the thermal treatment is in the range of 10-50%.

31. The process according to claim 1, wherein the hydrothermal, dilute acid hydrolysis is performed in at least two steps and wherein dissolved water soluble compounds are separated from a solid residue after the first step to prevent continued detrimental degradation.

32. (canceled)

33. (canceled)

34. (canceled)
